(19) United States
(12) Patent Application Publication
(10) Pub. No.: US 2014/0231328 A1
(43) Pub. Date: Aug. 21, 2014

(54) RAINWATER COLLECTION AND DISTRIBUTION DEVICE

(71) Applicant: Denis Sheehy, County Clare (IE)

(72) Inventor: Denis Sheehy, County Clare (IE)

(21) Appl. No.: 14/348,472

(22) PCT Filed: Sep. 28, 2012
(86) PCT No.: PCT/EP2012/069280

§ 371 Date: Mar. 28, 2014

(30) Foreign Application Priority Data
Sep. 28, 2011 (IE) S2011/0440

(51) Int. Cl. E03B 3/02; C02F 1/32; C02F 1/00; C02F 1/28; C02F 9/00; C02F 5/00

(52) U.S. Cl. CPC E03B 3/02; C02F 9/00; C02F 5/00; C02F 1/001; C02F 1/281; C02F 1/32
USPC 210/191; 210/257.1; 137/565.17; 137/395

(57) ABSTRACT

The present invention is directed towards a rainwater collection and distribution device comprising at least one substantially elongate collector tank having an open upper free end and a closed lower free end, whereby the elongate collector tank is dimensioned to fit within a downpipe with its open upper free end exposed to rainwater entering the downpipe; the rainwater collection and distribution device further comprising a connection conduit having a lower open end adjacent the lower closed end of the elongate collector tank, and an upper free end connected to a pump; whereby, a delivery conduit is connected between the pump and a water storage tank. The advantage of providing the pump is that complete control may be exerted over the delivery of the collected rainwater to a water storage tank. Unlike prior art solution, where collected rainwater must be discarded through opening a motorised valve, the collected rainwater is held for immediate delivery, if required, to a water storage tank, by use of the pump.

This invention relates to a rainwater collection and distribution device.

In particular, the present invention is directed towards rainwater collection devices for use within downpipes. Throughout this specification, the term “downpipe” shall be understood to encompass any type of drainage pipe installed in or on the side of a building to direct rainwater from a roof or a surface to a municipal drainage system or storm drain. In particular, the term “downpipe” shall be understood to also refer to any drainage apparatus which is used to direct water from a roof space down through the internal structure of a building, where the downpipe may be encased within the building walls and structures so that access to the downpipe is prohibited or extremely limited. The present invention may be equally applied to roadside drains and the like where the drain is used to pass rainwater into the municipal drainage system, and the access to the drain is limited.

Increasingly, governments and local authorities around the World are treating water is a scare commodity and water charges are being introduced as a means to cover the cost of treating and supplying water to residential and business properties. Water metering is carried out in approximately two-thirds of the OCED (Organisation for Economic Co-operation and Development) countries already and many of the remaining countries, including Ireland, have plans to introduce water metering within the next five to ten years.

Consequently, the capture and treatment of rainwater has become of interest in recent times. There are many types of rainwater harvesting systems known in the public domain. Typically rainwater is captured from a roof or large planar surface area and is passed, under gravity to a storage tank at or below ground level. This captured rainwater must then be treated and is typically pumped back to a water storage tank in an attic or service room close to the top of the building so that the water pressure in the building is created naturally under gravity.

Instead of pumping the rainwater from the rainwater storage tank at ground level, it has also been envisaged to collect rainwater flowing through existing downpipes and other existing infrastructures. There are a number of advantages to this. The existing downpipes and drainage system may be used by the rainwater collection device such that an overflows or the like may be simply passed into the downpipe and on to the municipal drainage system. Furthermore, the façade of the building is not greatly affected as much of the rainwater collection system may be installed within the downpipe so that the device is concealed from view.

A number of rainwater harvesting devices which utilise existing downpipes on a building are known from Australian Patent Publication Number AU2011211452A1 (MORGAN); U.K. Patent Publication Number GB2476281A (BRIDGE); and, U.K. Patent Publication Number GB2483522A (BLAKES).

Australian Patent Publication Number AU2011211452A1 discloses a rainwater collector which functions to store and divert rainwater that would otherwise not be utilised around the property. The rainwater collectors of AU2011211452A1 are modified downpipes which allow storage of rainwater for later use. The rainwater collectors disclosed in AU2011211452A1 may alternatively be used to divert rainwater to larger storage systems such as water tanks or water gardens using a simple, gravity based conduit system. The rainwater collectors of AU2011211452A1 comprise an overflow pipe such that any excess rainwater may be directed to municipal drainage systems as necessary.

The problem with the rainwater collector of AU2011211452A1 is that the system is extremely basic and does not allow for any control over the distribution of the collected rainwater. Furthermore, direct access to the downpipe is required in order to install the rainwater collector of AU2011211452A1 and this is not always possible, particularly in the case of large commercial buildings where the downpipes may be encased within concrete walls and structures of the building.

U.K. Patent Publication Number GB2476281A discloses a rainwater collection and storage system in which rainwater which is run off from a roof of a building is collected and stored in a system of gutters and downpipes which are adapted to retain the rainwater as well as divert excess rainwater to a municipal drainage system. The rainwater preferably passes through a filter into the downpipe which is in fluid communication with the system by means of a standard pipe. A one way valve may be provided to prevent backflow from a mains water supply into the rainwater collection and storage system supply. GB2476281A also discloses diverting rainwater directly from the downpipes to a toilet and the like by means of a standard size pipe.

As before, the control of the flow of the rainwater collected by the rainwater collection and storage system of GB2476281A is absent. This absence of any control is undesirable as the rainwater will flow under gravity along the path of least resistance which requires a complicated conduit system to be arranged. This could require extensive works to an existing building in order to install the gravity-based rainwater collection and storage system. Furthermore, the rainwater collection and storage system of GB2476281A requires access to the downpipes and cannot be retro-fit to existing buildings where the access to the downpipes is prohibited or extremely limited.

U.K. Patent Publication Number GB2483522A discloses a gutter downpipe for rainwater collection and remote release of the collected rainwater. The gutter downpipe is installed in place of a regular downpipe, and the gutter downpipe of GB2483522A is a modular and stackable unit which preferably includes an attachment means for attaching the modular and stackable units to a structure or a building. An electronics module is used to open and close a motorised valve in the gutter downpipe in order to release collected rainwater from the gutter downpipe.

Whilst the gutter downpipe of GB2483522A address some of the control issues surrounding earlier examples of downpipe-based rainwater collectors, the control is rudimentary and crude. Furthermore, GB2483522A refers to the collection of rainwater down along the side of a building from the downpipe. The gutter downpipe therefore has to be attached to the side wall of the building which is unsightly.

As it is known for large industrial sized buildings having substantially flat roofing to use downpipes through the building itself. The prior art rainwater collections systems which are used with downpipes are not suited to be used with substantially flat roofs. As mentioned hereinbefore, in large commercial buildings, a large flat roof may have a number of downpipes projecting downwardly through the building at several locations. Oftentimes, these downpipes are encased in concrete as part of the building structure and cannot be accessed. Therefore, prior art solutions cannot be applied to these types of downpipes.

It is a goal of the present invention to provide an apparatus that overcomes at least one of the above mentioned problems. And in particular it is a goal of the present invention to allow rainwater to be collected from downpipes which pass through a building from a position on a substantially flat planar roof.

### SUMMARY OF THE INVENTION

The present invention is directed to a rainwater collection and distribution device comprising at least one substantially elongate collector tank having an open upper free end and a closed lower free end, whereby the elongate collector tank is dimensioned to fit within a downpipe with its open upper free end exposed to rainwater entering the downpipe; the rainwater collection and distribution device further comprising a connection conduit having a lower open end adjacent the lower closed end of the elongate collector tank, and an upper free end connected to a pump; whereby, a delivery conduit is connected between the pump and a water storage tank.

The advantage of providing the pump is that complete control may be exerted over the delivery of the collected rainwater to a water storage tank. Unlike prior art solution, where collected rainwater must be discarded through opening a motorised valve, the collected rainwater is held for immediate delivery, if required, to a water storage tank, by use of the pump.

In a further embodiment, the rainwater collection and distribution device comprises a plurality of substantially elongate collector tanks, and a plurality of connection conduits; whereby, the upper free end of each of the plurality of connection conduits is connected to the pump and a single delivery conduit is connected between the pump and the water storage tank. In this manner, the controllable pump may be connected to a plurality of rainwater collectors which are concealed from view within a downpipe and the single pump may operate to pump rainwater from at least on of the plurality of substantially elongate collector tanks through to the water storage tank.

In a further embodiment, the rainwater collection and distribution device further comprises a photovoltaic panel and one or more batteries connected to the photovoltaic panel. This is advantageous as the energy collected by the photovoltaic panel(s) may be stored in the batteries and subsequently used to power the rainwater collection and distribution device.

In a further embodiment, the water storage tank is a dedicated rainwater storage tank. In another embodiment, the water storage tank comprises a mains water supply.

In a further embodiment, the rainwater collection and distribution device comprises a rainwater filtration means located along the rainwater outlet pipe from the dedicated rainwater storage tank.

In a further embodiment, the rainwater collection and distribution device comprises a rainwater filtration means located along the rainwater delivery conduit, intermediate the pump and the water storage tank.

In a further embodiment, the rainwater filtration means comprises a sand filter. In yet a further embodiment, the rainwater filtration means comprises a cotton block filter. In another embodiment, the rainwater filtration means comprises a carbon block filter. In a further embodiment, the rainwater filtration means comprises an ultra violet filter.

In a further embodiment, the rainwater filtration means comprises a chlorine source and mixing means for dosing the water in the rainwater filtration means with a predetermined amount of chlorine. Alternatively, in a further embodiment, the rainwater filtration means comprises a water softener.

In a further embodiment, the rainwater collection and distribution device further comprises a central controller and a rainwater level detection unit, whereby the rainwater level detection unit is arranged within the elongate collector tank to determine the level of rainwater collected within the elongate collector tank.

In a further embodiment, the central controller activates the pump when the level of rainwater in the elongate collector tank has reached an upper detection point and deactivates the pump if the level of rainwater in the elongate collector tank has dropped below a lower detection point. It will be understood that in the embodiment where a plurality of elongate collector tanks are connected to a single pump, the pump will be activated when the rainwater in at least one of the plurality of elongate collector tanks has reached the upper detection point, and, the pump may preferably only be deactivated if the level of rainwater in all of the plurality of elongate collector tanks has dropped below their lower detection points.

In a further embodiment, a water level detector is arranged in the water storage tank and the central controller deactivates the pump if the level of rainwater in the elongate collector tank reaches an upper detection point. In a preferred embodiment, signals and/or commands from the water level detector in the water storage tank prevail over signals and/or commands from the rainwater level detection unit within the elongate collector tank(s) such that if the water storage tank is deemed to have a sufficient amount of water, the pump will not be activated regardless of the level of rainwater in the elongate collector tank(s).

In a further embodiment, the elongate collector tank comprises an overflow conduit which is located adjacent the open upper free end of the elongate collector tank such that when the elongate collector tank is installed in its in-operation position within the downpipe, rainwater passing through the overflow conduit will flow into the downpipe.

In a further embodiment, the rainwater collection and distribution device comprises a wireless communications transceiver.

In a further embodiment, the rainwater collection and distribution device comprises a water quality measurement sensor.

In a further embodiment, the rainwater collection and distribution device comprises a temperature sensor and a water anti-freeze system. It will be understood that the water anti-freeze system may comprise an in-pipe heat cable which is located in the pipe work and water storage tanks including the rainwater collection and distribution device. The water anti-freeze system is controlled using feedback from the temperature sensor. For example, when the temperature drops to 2 degrees centigrade, the feedback from the temperature sensor would cause the central controller to switch on the in-pipe heat cable and bring the temperature of the water up. Once the temperature sensor detects a higher temperature of for example 5 degrees centigrade, the central controller may then switch off the in-pipe heat cable.

In a further embodiment, the rainwater collection and distribution device comprises a water meter sensor.

In a further embodiment, the rainwater collection and distribution device comprises a central controller. In one embodiment, the central controller runs an updatable firmware algorithm, and, in a further embodiment, the central controller comprises a memory to log all pump activations and data from sensors in the rainwater collection and distribution device.

In a further embodiment, data stored on the memory may be transmitted to a remote location using a wireless communications transmitter.

In a further embodiment, the rainwater collection and distribution device comprises a mains water supply connection and a controllable valve connected between the main water supply and the rainwater collection and distribution device.

In a further embodiment, the pump is a submersible pump; and, the connection conduit and the submersible pump are dimensioned to fit within the elongate collector tank, and, a portion of the delivery conduit is dimensioned to fit within the elongate collector tank.

The advantage of providing the connection conduit, the submersible pump, and, the portion of the delivery conduit within the elongate collector tank is that the majority of the rainwater collection and distribution device is concealed from view and thus the façade of the building is not impacted upon by the rainwater collection and distribution device.

In a further embodiment, the rainwater collection and distribution device comprises a control box and the elongate collector tank, whereby the control box comprises legs to allow the control box to be installed on a substantially flat roof, with the elongate collector tank being arranged beneath the control box and within a downpipe which projects downwardly from the substantially flat roof. The advantage of designing the rainwater collection and distribution device is such a manner is so that the rainwater collection and distribution device can sit on top of a building on a flat roof of the building, with the elongate collector tank installed within a downpipe which runs through the building. Downpipes of this type are typically encased in concrete within the building and access to the downpipes is limited.

### DETAILED DESCRIPTION OF EMBODIMENTS

The invention will be more clearly understood from the following description of some embodiments thereof, given by way of example only, with reference to the accompanying drawings, in which:

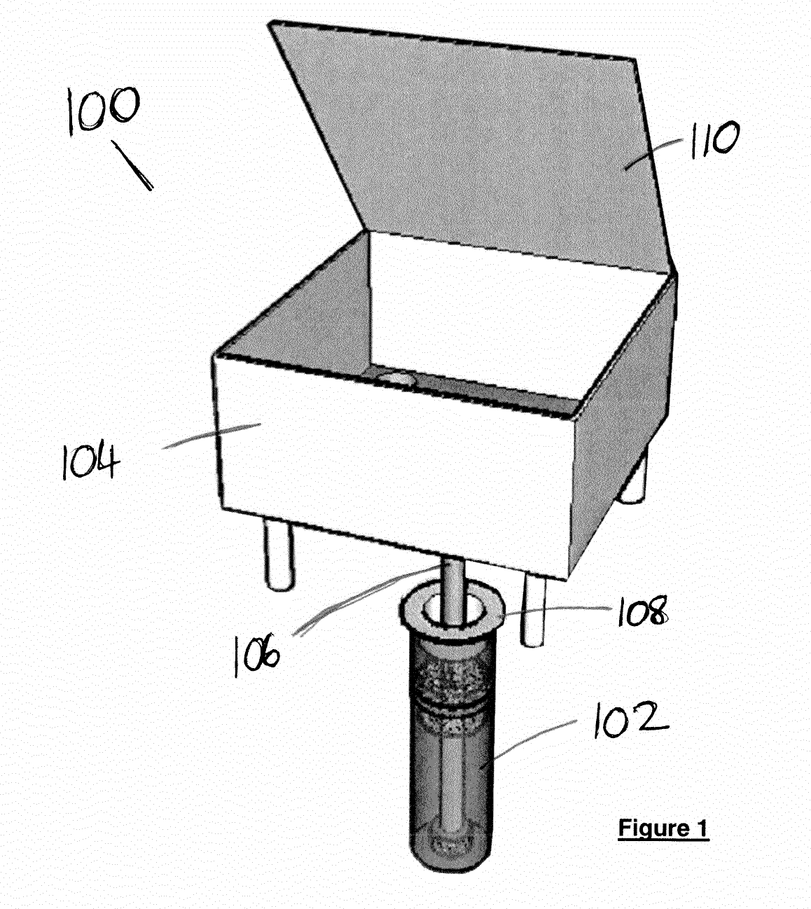

FIG. 1 is a perspective view of a rainwater collection and distribution device in accordance with the present invention;

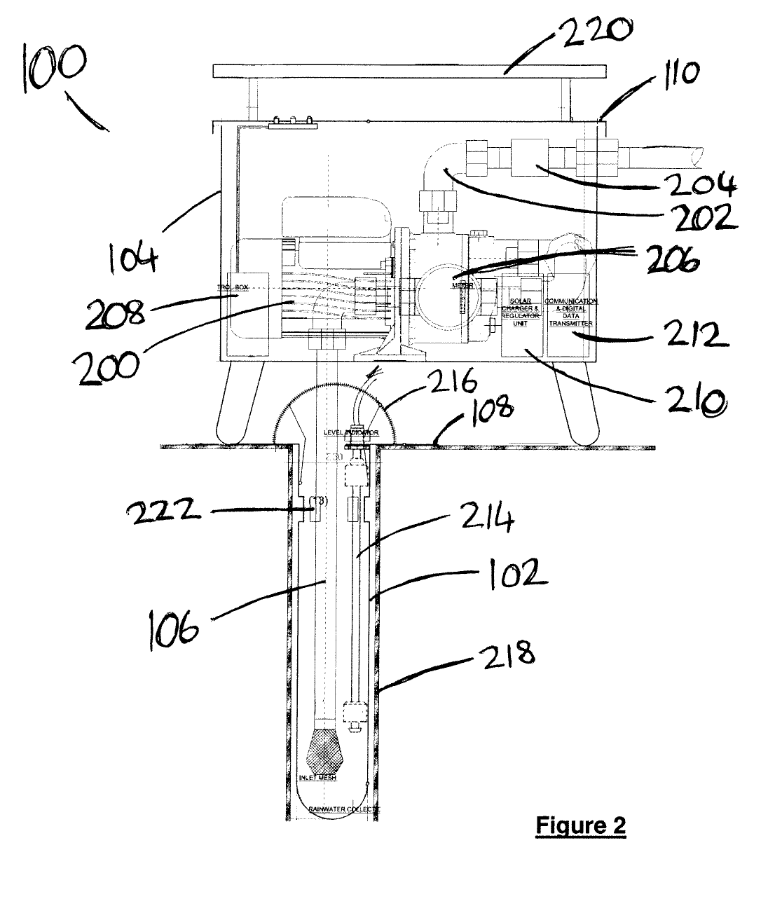

FIG. 2 is a side see-through view of the rainwater collection and distribution device of FIG. 1;

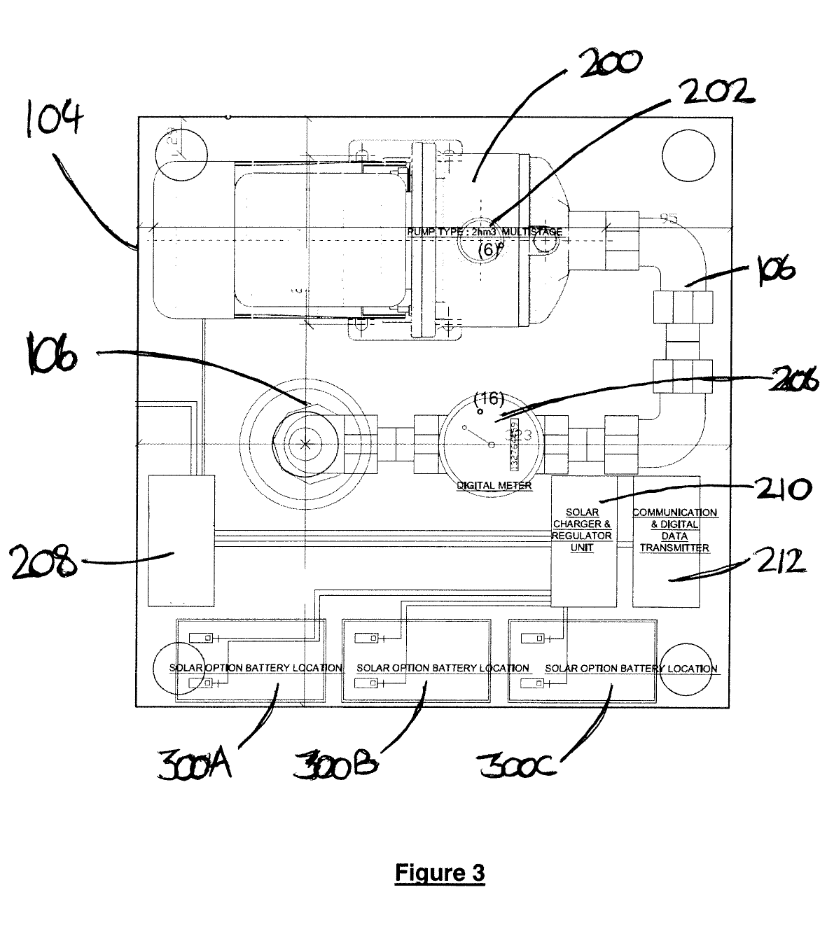

FIG. 3 is a top see-through view of the rainwater collection and distribution device of FIG. 1;

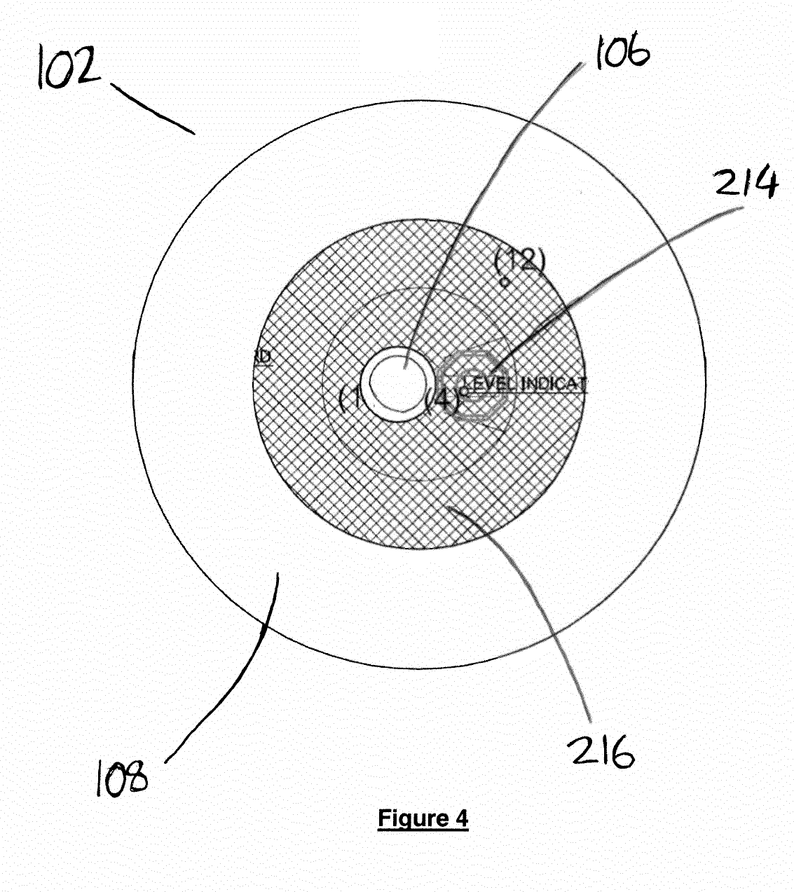

FIG. 4 is a top view of an elongate collector tank installed within a down pipe in accordance with the present invention; and,

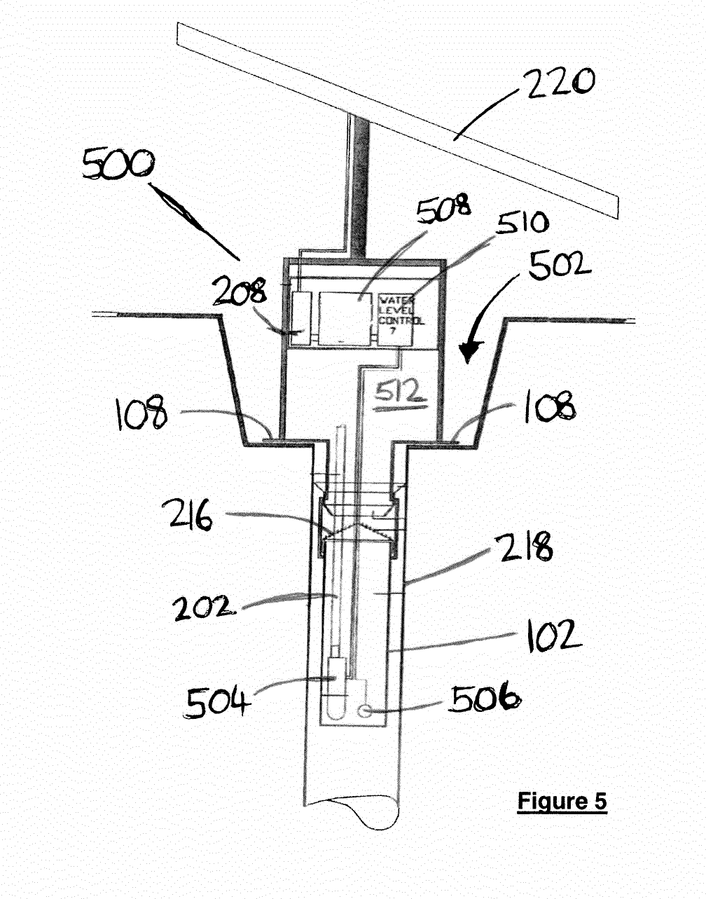

FIG. 5 is a side see-through view of a rainwater collection and distribution device in accordance with an alternative embodiment of the present invention.

Referring to FIG. 1, there is provided a water collection and distribution device indicated generally by reference numeral 100. The water collection and distribution device 100 comprises an elongate collector tank 102 connected to a roof-mounted control box 104 via a connection conduit 106.

The elongate collector tank 102 comprises an open upper free end and a closed lower free end, whereby the elongate collector tank is dimensioned to fit within a downpipe (not shown) when it is installed in situ. A flanged lip 108 arranged around the diameter of the upper free end allows the elongate collector tank 102 to be lowered into a downpipe and held in situ within the downpipe. The open upper free end of the elongate collector tank 102 will be exposed to rainwater entering the downpipe such as to collect water in the elongate collector tank 102.

The connection conduit 106 comprises a lower open end adjacent the lower closed end of the elongate collector tank 102, and an upper free end connected to a pump (not shown) which is housed in the roof-mounted control box 104.

The roof-mounted control box 104 comprises a protective cover 110 which may be removed to assess component parts, such as the pump, which are housed within the roof-mounted control box 104. It will be appreciated that the roof-mounted control box 104 may not necessarily be roof mounted, and may alternatively be located within a building.

Referring now to FIGS. 2 and 3, the water collection and distribution device 100 is shown in situ on a roof with a downpipe 218.

The elongate collector tank 102 is elongate in a substantially vertical axis, and is lowered into a downpipe 218 with the flanged lip 108 to hold the elongate collector tank 102 in situ against a roof surface. A leaf guard 216 is installed over the open upper free end of the elongate collector tank 102. The connection conduit 106 passes through a purpose-made void in the leaf guard 216 so as to connect to the pump 200.

The water collection and distribution device 100 further comprises a central controller 208 which is housed within the roof-mounted control box 104. The central controller 208 may comprise a processor, memory and an updateable firmware algorithm for controlling the operation of the water collection and distribution device 100.

A water meter 206, which is preferably a digital water meter, is provided along the connection conduit 106. The water meter 206 is in communication with the central controller 208 whereby the central controller 208 may advantageously log the flow rate of water passing through the connection conduit 106.

The pump 200 pumps rainwater through a delivery conduit 202 and into a water storage tank (not shown). A non-return valve 206 may be advantageously installed on the delivery conduit 202 adjacent the pump 200 and/or adjacent the inlet to the water storage tank.

A photovoltaic panel 220 may be mounted on the protective cover 110. The electrical energy from the photovoltaic panel 220 is managed by a solar power controller 210 and the electrical energy may be stored in a bank of batteries 300A, 300B, 300C. The power from the photovoltaic panel 220 may be used to power the water collection and distribution device 100 and/or be delivered to other appliance or exported to the electricity supply grid.

A wireless communications transceiver 212 is provided to allow the water collection and distribution device 100 to communicate with remotely located servers and/or controllers. The central controller 208 is connected to the wireless communications transceiver 212 so as to provide information upon receipt of a request. The wireless communications transceiver 212 may be a GSM based transceiver or indeed any type of near wireless communications protocol such as Bluetooth or WiFi may be used. Alternatively, radio communications protocols such as GSM, LTE and the like may be used.

A rainwater level detection unit 214 is provided to detect when the level of rainwater in the elongate collector tank 102 has reached an upper detection point or a lower detection point.

An overflow conduit 222 is provided adjacent the open upper free end of the elongate collector tank 102 such that when the elongate collector tank 102 is installed in its in-operation position within the downpipe 218, rainwater passing through the overflow conduit 22 will flow into the downpipe 218.

With reference to FIG. 4, the elongate collector tank 102 is shown to comprise a meshed leaf guard 216 over the open upper free end of the elongate collector tank 102. The connection conduit 106 passes through a purpose-made void in the leaf guard 216 towards its connection to a pump (not shown). The rainwater level detection unit 214 is positioned adjacent the connection conduit 106 in the elongate collector tank 102. The flanged lip 108 is also shown to extend around the diameter of the open upper free end of the elongate collector tank 102.

Referring to FIG. 5, wherein like parts previously described have been assigned the same reference numerals, there is provided a rainwater collection and distribution device indicated generally by reference numeral 500. The rainwater collection and distribution device 500 comprises an elongate collector tank 102 which, as before, is dimensioned to be installed within a standard width downpipe 218. The water collection and distribution device 500 comprises a submersible pump 504 in this embodiment which is connected via the delivery conduit 202 to a dedicated rainwater storage tank 512, although it will be readily appreciated that the delivery conduit may pass rainwater to a rainwater storage tank, a mains supply water storage tank; and, the rainwater may be preferably treated by a filtration means (not shown) prior to delivery to the dedicated rainwater storage tank 512. The filtration means may comprise a sand filter, a cotton block filter, a carbon block filter, or an ultra violet filter. Chlorine dosing and/or water softening may also be applied to the treatment of the rainwater.

The rainwater collection and distribution device 500 also comprises a rainwater level detection unit 506 to detect when the level of rainwater in the elongate collector tank 102 is low. A meshed guard 216 is arranged above the elongate collector tank 102, and within the downpipe 218.

As before, flanged lips 108 are used to hold the elongate collector tank 102 in situ within the downpipe 218 and in this embodiment, the control box may be positioned in a guttering 502. Sensors such as the water level controller 510 and the back-up battery power supply 508 are shown in addition to the photovoltaic panel 220.

It will be understood that the rainwater collection and distribution device 100, 500 may be preferably power by energy from the photovoltaic panel 220, but may also comprise a back-up battery 508 and/or a electricity mains supply connection.

It is also envisaged that the rainwater collection and distribution device 100, 500 will comprise a water quality measurement sensor to measure the quality of the rainwater through turbidity and other such in-flow measurement techniques. An appropriate treatment method and/or chlorine dosing amount may be configured in response to the measure of the quality of the rainwater.

A temperature sensor and an associated water anti-freeze system may also be provided to ensure that the rainwater collection and distribution device 100, 500 does not freeze over in low temperatures.

The central controller 208 preferably comprises a memory to log all pump activations and data from the various sensors in the rainwater collection and distribution device 100, 500. The information from the central controller 208 or from the various sensors directly may be transmitted to a remote location using a wireless communications transmitter or transceiver.

It is foreseen that the rainwater collection and distribution device 100, 500 is connected to a mains water supply connection with a motorised valve connected between the mains water supply and the rainwater collection and distribution device 100, 500 so that mains supply water can be feed through the rainwater collection and distribution device 100, 500 if required for cleansing and the like.

In use, the water collection and distribution device 100, 500 is primarily used to collect rainwater which falls onto a surface such as a roof of a building and into one of the downpipes of the buildings.

The water collection and distribution device 100, 500 comprises the elongate collector tank 102 which is located in the downpipe, adjacent the top, middle, or bottom of the downpipe, and collects and retains indefinitely rainwater which passes into the downpipe. The collected rainwater is retained until such time as the rainwater level as determined by the rainwater level detection unit has reached a predefined upper detection level/point. Once the rainwater level reached the upper detection point, the central controller activates the pump. Prior to activating the pump, the central controller may query a water level diction unit in the water storage tank to assess if there is capacity in the water storage tank to receive rainwater form the elongate collector tank. If there is not capacity, the pump will not be activated. If there is capacity, the central controller activates the pump as the rainwater level reached the upper detection point.

When the rainwater level in the elongate collection tank has reduced so that the rainwater level is below a lower detection point, the central controller deactivates the pump.

Each cycle is controlled by the central controller and the activity is recorded and logged by the central controller by later retrieve by wired or wireless means. All data is retained in a memory unit in the central controller until a request to transfer is received by the wireless communications transceiver. Once the wireless communications transceiver receives the request, the wireless communications transceiver transmits the data to a remotely located monitoring station.

If there is no capacity in the water storage tank, the pump will not be activated and any additional rainwater collected by the elongate collection tank will be permitted to flow through the overflow conduit and down the downpipe into a municipal drainage system.

It is envisaged that a status indicator will be provided on the protective cover of the control box, and/or the status may be monitored remotely using the wireless communications transceiver.

The terms “comprise” and “include”, and any variations thereof required for grammatical reasons, are to be considered as interchangeable and accorded the widest possible interpretation.

It will be understood that the components shown in any of the drawings are not necessarily drawn to scale, and, like parts shown in several drawings are designated the same reference numerals.

The invention is not limited to the embodiments hereinbefore described which may be varied in both construction and detail.

1. A rainwater collection and distribution device comprising at least one substantially elongate collector tank having an open upper free end and a closed lower free end, whereby the elongate collector tank is dimensioned to fit within a downpipe with its open upper free end exposed to rainwater entering the downpipe;
the rainwater collection and distribution device further comprising a connection conduit having a lower open end adjacent the lower closed end of the elongate collector tank, and an upper free end connected to a pump; whereby, a delivery conduit is connected between the pump and a water storage tank.

2. A rainwater collection and distribution device as claimed in claim 1, wherein, the rainwater collection and distribution device comprises a plurality of substantially elongate collector tanks as claimed in claim 1, and a plurality of connection conduits as claimed in claim 1; whereby, the upper free end of each of the plurality of connection conduits is connected to the pump and a single delivery conduit is connected between the pump and the water storage tank.

3. (canceled)

4. A rainwater collection and distribution device as claimed in claim 1, wherein, the water storage tank is a dedicated rainwater storage tank.

5. A rainwater collection and distribution device as claimed in claim 1, wherein, the water storage tank comprises a mains water supply.

6. A rainwater collection and distribution device as claimed in claim 4, wherein, the rainwater collection and distribution device comprises a rainwater filtration means located along the rainwater outlet pipe from the dedicated rainwater storage tank, the rainwater filtration means comprising one of more of the following:
a sand filter.
a cotton block filter,
a carbon block filter, and
an ultra violet filter.

7. A rainwater collection and distribution device as claimed in claim 5, wherein, the rainwater collection and distribution device comprises a rainwater filtration means located along the rainwater delivery conduit, intermediate the pump and the water storage tank.

8-11. (canceled)

12. A rainwater collection and distribution device as claimed in claim 6, wherein, the rainwater filtration means comprises a chlorine source and mixing means for dosing the water in the rainwater filtration means with a predetermined amount of chlorine, and preferably, the rainwater filtration means comprises a water softener.

13. (canceled)

14. A rainwater collection and distribution device as claimed in claim 1, wherein, the rainwater collection and distribution device further comprises a central controller and a rainwater level detection unit, whereby the rainwater level detection unit is arranged within the elongate collector tank to determine the level of rainwater collected within the elongate collector tank.

15. A rainwater collection and distribution device as claimed in claim 14, wherein, the central controller activates the pump when the level of rainwater in the elongate collector tank has reached an upper detection point and deactivates the pump if the level of rainwater in the elongate collector tank has dropped below a lower detection point.

16. A rainwater collection and distribution device as claimed in claim 14, wherein, a water level detector is arranged in the water storage tank and the central controller deactivates the pump if the level of rainwater in the elongate collector tank has dropped below a lower detection point.

17. A rainwater collection and distribution device as claimed in claim 1, wherein, the elongate collector tank comprises an overflow conduit which is located adjacent the open upper free end of the elongate collector tank such that when the elongate collector tank is installed in its in-operation position within the downpipe, rainwater passing through the overflow conduit will flow into the downpipe.

18. A rainwater collection and distribution device as claimed in claim 1, wherein, the rainwater collection and distribution device comprises a wireless communications transceiver.

19. A rainwater collection and distribution device as claimed in claim 1, wherein, the rainwater collection and distribution device comprises one or more of the following:
a water quality measurement sensor,
a water meter sensor, and
a photovoltaic panel and one or more batteries connected to the photovoltaic panel.

20. A rainwater collection and distribution device as claimed in claim 1, wherein, the rainwater collection and distribution device comprises a temperature sensor and a water anti-freeze system.

21. (canceled)

22. A rainwater collection and distribution device as claimed in claim 1, wherein, the rainwater collection and distribution device comprises a central controller.

23. A rainwater collection and distribution device as claimed in claim 22, wherein, the central controller runs an updatable firmware algorithm.

24. A rainwater collection and distribution device as claimed in claim 22, wherein, the central controller comprises a memory to log all pump activations and data from sensors in the rainwater collection and distribution device.

25. A rainwater collection and distribution device as claimed in claim 24, wherein, data stored on the memory may be transmitted to a remote location using a wireless communications transmitter.

26. A rainwater collection and distribution device as claimed in claim 1, wherein, the rainwater collection and distribution device comprises a mains water supply connection and a controllable valve connected between the main water supply and the rainwater collection and distribution device.

27. A rainwater collection and distribution device as claimed in claim 1, wherein, the pump is a submersible pump; and, the connection conduit and the pump are dimensioned to fit within the elongate collector tank, and, a portion of the delivery conduit is dimensioned to fit within the elongate collector tank.
